(19) United States
(12) Patent Application Publication
(10) Pub. No.: US 2024/0269913 A1
(43) Pub. Date: Aug. 15, 2024

(54) BLOW MOLD FOR PLASTIC BOTTLE

(71) Applicant: Technical Response, Inc., Knoxville, TN (US)

(72) Inventor: Leonard Scott Huff, Knoxville, TN (US)

(73) Assignee: Technical Response, Inc., Knoxville, TN (US)

(21) Appl. No.: 18/545,119

(22) Filed: Dec. 19, 2023

(30) Foreign Application Priority Data
Feb. 9, 2023 (CN) 2023202899115

(51) Int. Cl. B29C 49/62; B29C 49/24; B29C 49/28; B29C 49/48; B29C 49/78

(52) U.S. Cl. CPC B29C 49/62; B29C 49/2408; B29C 49/28; B29C 49/48; B29C 49/78; B29C 2049/4856; B29C 2049/627

(57) ABSTRACT

Disclosed is a blow mold for plastic bottle, which comprises: a mold body, two exhaust channels, a label plate, and a vacuum suction assembly; the mold cavity is arranged in the mold body, the mold cavity is used for shaping the bottle embryo; the two exhaust channels are connected to the mold cavity; the vacuum suction assembly is connected to the two exhaust channels and used to suction out the gas inside the mold cavity. The present disclosure starts the vacuum suction assembly when blow molding the bottle embryo to carry out an active exhaust operation, reduces the generation of air bubbles between the bottle embryo and the label plate and the interior of the label plate, improves the adhesion between the bottle and the label plate, also reduces the air bubbles and delamination of the interior of the laminated label plate in the process of blow molding

### TECHNICAL FIELD

The present disclosure relates to the technical field of plastic bottle processing, and particularly relates to a blow mold for plastic bottle.

### BACKGROUND

In the prior art, when blow molding, a label is laminated on the surface of the bottle body for protecting or decorating the bottle body, and in the process, a groove is usually processed on the splicing surface of the mold, and after the mold is closed, high-pressure air is blown into the embryo of the bottle, the embryo of the bottle expands, and excess air between the embryo of the bottle and the label can only be passively vented through the groove of the upper portion, which results in the formation of a body of the bottle after the embryo is expanded by blow molding and bubbles are generated on the bonded portion of the bottle and the label, resulting in the lack of adhesion between the bottle and the label, which results in the label being dislodged or having a poor appearance.

### SUMMARY

In view of the above mentioned deficiencies of the prior art, an object of the present disclosure is to provide a blow mold for plastic bottle, aiming to reduce the air bubbles between the bottle and the label caused by the difficulty in exhausting the mold in the prior art, which results in the lack of adhesion between the bottle and the label, leading to the label falling off or having a poor appearance.

In order to achieve the above purpose, the disclosed technical scheme of the present disclosure is as follows.

In a first aspect, the embodiments of the present disclosure provide a blow mold for plastic bottle, which includes: a mold body; the mold body is arranged with a mold cavity used to contain a bottle embryo and a blowing port connected to the mold cavity, the present disclosure comprises:
Two exhaust channels, the two exhaust channels are arranged on both sides of the mold body, the two exhaust channels are connected to the mold cavity;
A label plate, the label plate is arranged in the mold cavity;
A vacuum suction assembly, the vacuum suction assembly is arranged outside the mold body and is connected to the two exhaust channels, the vacuum suction assembly is used to suck out gas from the mold cavity;
The label plate is adsorbed within the mold cavity before blow molding, and the label plate is bonded to an outer surface of the bottle embryo during blow molding with expansion of the bottle embryo.

As a further improved technical solution, the present disclosure further comprises two ventilation grooves, the two ventilation grooves are connected to the two exhaust channels and the mold cavity, and the two ventilation grooves are arranged in the mold body, the two ventilation grooves comprise a main flow path and three auxiliary flow paths, the three auxiliary flow paths are uniformly arranged along the vertical direction from top to bottom and are connected to the mold cavity, the main flow path is connected to the two exhaust channels.

As a further improved technical solution, the mold body comprises a first module and a second module, the first module and the second module comprise a part of the mold cavity respectively, and the two ventilation grooves and the two exhaust channels are arranged in the second module.

As a further improved technical solution, the label plate comprises a plurality of structural layers, the plurality of the structural layers are arranged stacked.

As a further improved technical solution, the mold body is further provided with positioning holes, the positioning holes are connected to the mold cavity, and the positioning holes are used to absorb and position the label plate.

As a further improved technical solution, the mold body is further provided with a vacuum pipeline, the vacuum pipeline is connected to the positioning holes.

As a further improved technical solution, the vacuum suction assembly comprises:
A pneumatic connecting member, the pneumatic connecting member is disposed on both sides of the mold body and connected to the exhaust channel;
A ventilation pipe, the ventilation pipe is connected to the connecting member;
A vacuum tank, the vacuum tank is arranged at one end of the ventilation pipe away from the mold body; and
A vacuum pump, the vacuum pump is connected to the vacuum tank and the vacuum pump is used to extract gas from the vacuum tank.

As a further improved technical solution, the vacuum suction assembly further comprises a check valve, the check valve is arranged on the ventilation pipe, and the check valve is used to prevent the external gas from flowing back into the mold cavity.

As a further improved technical solution, the vacuum suction assembly further comprises an inductive member, the inductive member is arranged on a splicing surface of the second module, and the inductive member is used for sensing whether the first module is spliced with the second module.

The technical solution adopted in the present disclosure has the following beneficial effects.

The present disclosure provides a plastic bottle blow mold comprising: a mold body, an exhaust channel, a label plate, and a vacuum suction assembly, the mold body is arranged with a mold cavity used to contain a bottle embryo and a blowing port connected to the mold cavity, the two exhaust channels are arranged on front side and rear side of the mold body, the two exhaust channels are connected to the mold cavity; the present disclosure by opening the exhaust channels on both sides of the middle of the mold body to increase the exhaust volume, which in turn makes the air volume of exhaust inside the mold cavity is larger, reducing the generation of air bubbles between the bottle embryo and the label plate, and inside the label plate. At the same time, the exhaust channel is connected to the vacuum suction assembly, which can be activated when blow molding the preforms, so as to carry out the active exhaust operation and reduce the air bubbles between the preforms and the label plate, and improve the adhesion between the bottle and the label plate. It can also reduce air bubbles and delamination inside the laminated label plate during the blow molding process, increase the yield and improve the appearance of the product.

### BRIEF DESCRIPTION OF THE DRAWINGS

FIG. 1 shows a schematic diagram of the exploded structure of the mold body of a blow mold for plastic bottle provided by the present disclosure;

FIG. 2 shows a schematic diagram of a first sectional structure of the blow mold for plastic bottle provided by the present disclosure;

FIG. 3 shows a schematic diagram of a first sectional structure of a second module of the blow mold for plastic bottle provided by the present disclosure;

FIG. 4 is a schematic diagram of a second sectional structure of the second module of the blow mold for plastic bottle provided by the present disclosure; and

FIG. 5 is a schematic diagram of the sectional structure of a label plate of the blow mold for plastic bottle provided by the present disclosure.

Attached drawing marks: 1—mold body; 2—ventilation groove; 3—exhaust channel; 4—vacuum suction assembly; 5—mold cavity; 6—blowing port; 7—blowing assembly; 10—first module; 11—second module; 12—structural layer; 13—positioning hole; 14—vacuum pipeline; 15—ventilation pipe; 16—vacuum tank; 17—vacuum pump; 18—check valve; 19—inductive member; 20—bottle embryo; 21—label plate; 22—pneumatic connecting member.

### DETAILED DESCRIPTION OF THE EMBODIMENTS

In order to make the purpose, technical solution and effect of the present disclosure clearer and more explicit, the present disclosure is described in further detail hereinafter with reference to the accompanying drawings and by way of embodiments. It should be understood that the specific embodiments described herein are only for explaining the present disclosure and are not intended to limit the present disclosure.

It should be noted that when a component is to be “fixed to” or “set on” another component, it may be directly on the other component or indirectly on the other component. When a component is to be “attached” to another component, it may be attached directly to the other component or indirectly to the other component.

It should also be noted that the same or similar symbols in the accompanying drawings of the embodiments of the present disclosure correspond to the same or similar components, in the description of the present disclosure, it is to be understood that the terms “top”, “bottom”, “left”. In the description of the present disclosure, it should be understood that if there are terms such as “up”, “down”, “left”, “right”, etc., which indicate orientation or positional relationships based on those shown in the accompanying drawings, such terms are used only for the purpose of facilitating the description of the present disclosure and simplifying the description, and are not intended to indicate or imply that the devices or components referred to must be of a particular orientation, constructed and operated with a particular orientation. Therefore, the terms describing the positional relationships in the accompanying drawings are used for exemplary illustration only and are not to be construed as a limitation of the present disclosure, and the specific meanings of the terms may be understood by a person of ordinary skill in the art in the light of the specific circumstances.

Furthermore, the terms “first” and “second” are used for descriptive purposes only and are not to be understood as indicating or implying relative importance or implicitly specifying the number of technical features indicated. As a result, a feature defined with “first” or “second” may include one or more such features, either explicitly or implicitly. In the description of the present disclosure, “more” means two or more, unless otherwise expressly and specifically limited.

### Embodiment

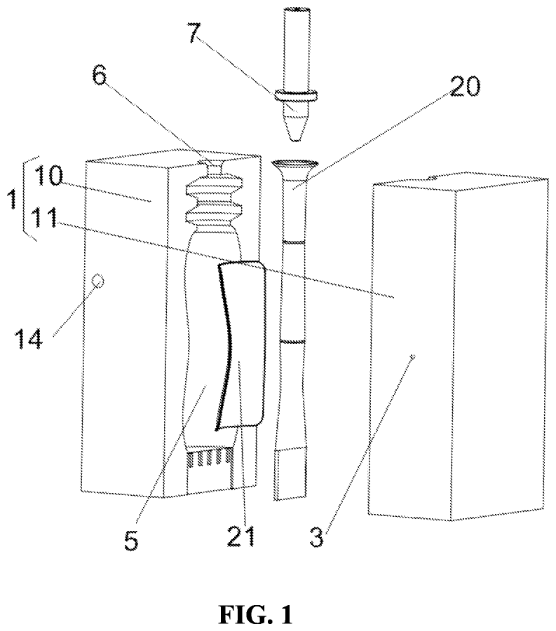

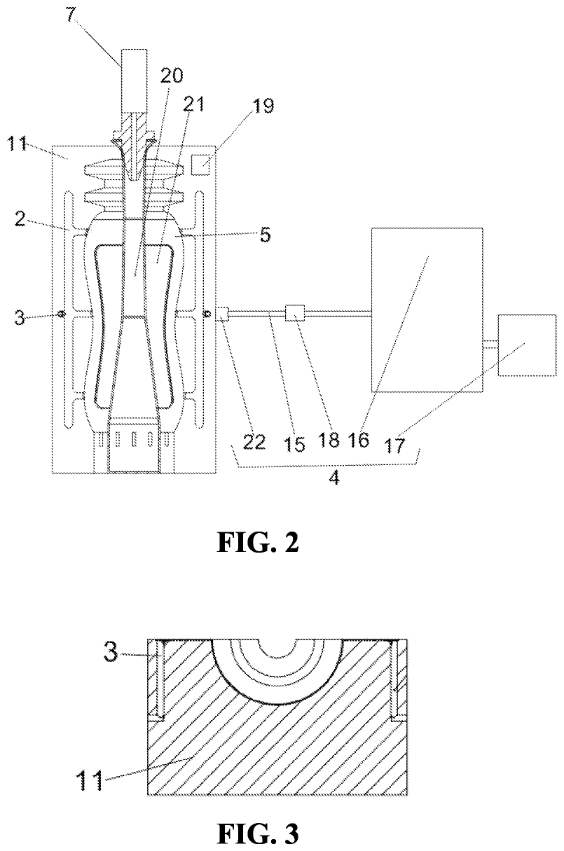

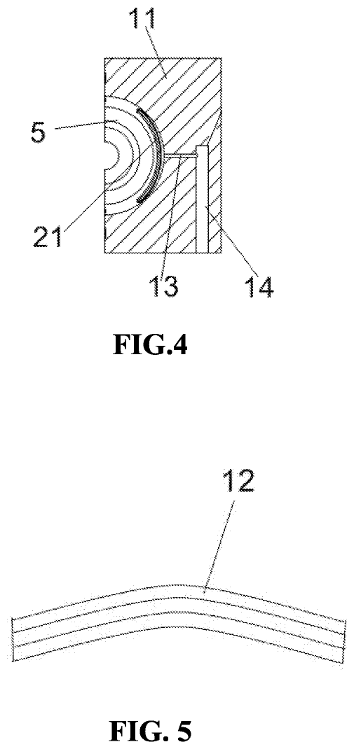

As shown in FIGS. 1-5, disclosed is a blow mold for plastic bottle. FIG. 1 is a schematic diagram of the exploded structure of the mold body of a blow mold for plastic bottle provided by the present disclosure. FIG. 2 is a schematic diagram of a first sectional structure of the blow mold for plastic bottle provided by the present disclosure. FIG. 3 is a schematic diagram of a first sectional structure of a second module of a blow mold for plastic bottle provided by the present disclosure. FIG. 4 is a schematic diagram of a second sectional structure of the second module of the blow mold for plastic bottle provided by the present disclosure. FIG. 5 is a schematic diagram of a sectional structure of a label plate of the blow mold for plastic bottle provided by the present disclosure. The blow mold for plastic bottle disclosed in the present disclosure comprises: a mold body 1, the mold body 1 is provided with a mold cavity 5, the mold cavity 5 is used to hold a bottle embryo 20, and the mold body 1 is also provided with a blowing port 6, the blowing port 6 is connected to the mold cavity 5, and the blow mold for plastic bottle further comprises: two exhaust channels 3, a label plate 21, a vacuum suction assembly 4, the two exhaust channels 3 are symmetrically provided on the mold body 1, the two exhaust channels 3 are connected to the mold cavity 5, the label plate 21 is arranged in the mold cavity 5, the vacuum suction assembly 4 is symmetrically located on both sides of the mold body 1 and is connected to the two exhaust channels 3, the vacuum suction assembly 4 is used to suction out gas in the mold cavity 5.

The working principle of the blow mold for plastic bottle provided in this embodiment is as follows: when using the present disclosure, the bottle embryo 20 is first placed in the mold cavity 5, and before blow molding, the label plate 21 is placed to fit the mold cavity 5, and then the bottle embryo 20 in the mold body 1 is blown through the blowing port 6. During the blowing process, the gas between the bottle embryo 20 and the label plate 21 is vented through the two exhaust channels 3. After blowing, the bottle embryo 20 expands to form a plastic bottle, and the label plate 21 is bonded to the outer surface of the plastic bottle, and the final shape of the plastic bottle is the same as the shape of the mold cavity 5. At the same time as blow molding, the vacuum suction assembly 4 is activated to actively suction out the gas between the bottle embryo 20 and the mold body 1 to accelerate the exhaust, to avoid the generation of air bubbles between the bottle embryo 20 and the label plate 21, and then to realize the process of blow molding for plastic bottle.

The beneficial effect of the blow mold for plastic bottle provided in this embodiment is at least as follows: the present disclosure can reduce the generation of air bubbles between the bottle embryo 20 and the label plate 21 during the blow molding process by opening the two exhaust channels 3 on the mold body 1 in order to increase the volume of the exhaust gas, and thus make the gas exhaust volume inside the mold cavity 5 larger, and also reduce the generation of air bubbles between the bottle embryo 20 and the label plate 21 during the blow molding process, and at the same time, there is a vacuum suction assembly 4 connected to the outside of the two exhaust channels 3, which can then start the vacuum suction assembly when blowing the bottle embryo 20, thereby can carry out an active exhaust operation, reduce the generation of air bubbles between the bottle embryo 20 and the label plate 21, and also reduce the generation of air bubbles and lower the interior of the label plate 21 during the blow mold process, enhance the adhesion between the molded bottle embryo 20 and the label plate 21, and raise the yield and improve the appearance quality of the product.

In the embodiments of the present disclosure, the two ventilation grooves 2 are connected to the two exhaust channels 3 and the mold cavity 5, and the two ventilation grooves 2 are set in the mold body 1, and the two ventilation grooves 2 include a main flow channel and three auxiliary flow channels, and the three auxiliary flow channels are uniformly arranged along the vertical direction from the top to the bottom, and all are connected to the mold cavity 5, and the main flow channel is connected to the two exhaust channels 3, and the three auxiliary flow channels are uniformly arranged, making the air pressure of mold cavity 5 more balanced, more conducive to the exhaust during blow molding, and the exhaust speed is faster. In the other embodiments of the present disclosure, there is no limitation on the number of the auxiliary runners, so as to apply to various shapes of the bottle embryo 20.

As a further solution, as shown in FIG. 1, the mold body 1 comprises a first module 10 and a second module 11, the mold cavity 5 and the blowing port 6 are arranged in the first module 10 and the second module 11, and the two ventilation grooves 2 and the two exhaust channels 3 are arranged in the second module 11.

Specifically, in one embodiment, the mold body 1 comprises a first module 10 and a second module 11, and the first module 10 and the second module 11 are of a symmetrical structure, which is more convenient for modifying and processing the mold cavity 5 inside the mold. Moreover, in the embodiment of the present disclosure, the first module 10 and the second module 11 may also be of an asymmetrical structure, but the first module 10 and the second module 11 comprise a part of the mold cavity 5 respectively, when the two modules are put together, a complete mold cavity 5 is formed, so as to facilitate the blow molding of the bottle embryo into different shapes. Furthermore, in one embodiment of the present disclosure, the second module 11 comprises two ventilation grooves 2 and two exhaust channels 3, and in other embodiments, the first module 10 comprises two ventilation grooves 2 and two exhaust channels 3, so as to avoid the problem of substandard blow molding shape of the preform 20 caused by the opening of the two ventilation grooves 2 being too large.

As a further embodiment, as shown in FIG. 5, the label plate 21 comprises a plurality of structural layers 12, the plurality of the structural layers 12 are arranged in a stack.

Specifically, in one embodiment, the label plate 21 may be composed of a single structural layer 12 or multiple structural layers 12, and the multiple structural layers 12 are arranged in a stacked arrangement, and because of the multi-layer structure of the label plate 21 itself, the poor fit between the structural layers 12 may also lead to the generation of air bubbles between the structural layers 12, so when the blow molding operation is performed on the bottle embryo 20, the vacuum suction assembly 4 sucks out excess gas from the mold cavity 5 while also sucking out the gas between the structural layers 12, thereby reducing the air bubbles generated between the stacked layers 12. Furthermore, in one embodiment of the present disclosure, the structural layers 12 are used for decorating the bottle embryo 20. and in other embodiments of the present disclosure, the structural layers 12 may also be used for protecting other diaphragms of the bottle embryo 20.

As a further implementation, as shown in FIG. 4, the mold body 1 is also provided with positioning holes 13, the positioning holes 13 are connected to the mold cavity 5, and the positioning holes 13 are used to adsorb and position the label plate 21.

Specifically, in one embodiment, the positioning holes 13 are also arranged on the mold body 1. In this implementation of the present disclosure, the positioning holes 13 are arranged on the second module 11 and are at a different level from the two exhaust channels 3, and the positioning holes 13 are connected to the mold cavity 5. In other embodiments of the present disclosure, the positioning holes 13 are not only arranged on the second module 11, but also arranged on the first module 10, before blow molding, the mold body 1 is opened, and the two pieces of label plates 21 are fed into the first module 10 and the second module 11, respectively, to fit with the body 1 and be adsorbed at the positioning holes 13. And then, the mold body 1 is closed, and after blow molding, the positioning holes 13 are blocked, and the label plates 21 are released and bonded to the molded bottle embryo 20.

Furthermore, as shown in FIG. 4, the mold body 1 comprises a vacuum pipeline 14, the vacuum pipeline 14 is connected to the positioning holes 13.

Specifically, in one embodiment, the vacuum pipeline 14 is arranged on the mold body 1. In the implementation of the present disclosure, the vacuum pipeline 14 is arranged on the second module 11 and is not connected to the two exhaust channels 3, and the vacuum pipeline 14 is connected to the positioning holes 13, and in other implementations of the present disclosure, the vacuum pipeline 14 is not only arranged on the second module 11, but also on the first module 10. Before blow molding, a negative pressure is provided by the vacuum pipeline 14 to adsorb the label plate 21. After the mold body 1 is closed, and before blowing into the high-pressure gas is started, the positioning holes 13 are blocked, the negative pressure is invalidated, and the label plate 21 is released and adhered to the bottle embryo 20.

Furthermore, as shown in FIG. 2, the vacuum suction assembly 4 comprises: a pneumatic connecting member 22, a ventilation pipe 15, a vacuum tank 16, and a vacuum pump 17; the pneumatic connecting member 22 is arranged on front side and rear side of the mold body 1 and is connected to the two exhaust channels 3; the ventilation pipe 15 is connected to the pneumatic connecting member 22; the vacuum tank 16 is arranged at one end of the ventilation pipe 15 away from the mold body 1; the vacuum pump 17 is connected to the vacuum tank 16; and the vacuum pump 17 is used to extract the gas inside the vacuum tank 16.

Specifically, the pneumatic connecting member 22 is arranged on front side and rear side of the mold body 1, and the pneumatic connecting member 22 is connected to the two exhaust channels 3, and the pneumatic connecting member 22 is connected to a ventilation pipe 15, and the other end of the ventilation pipe 15 is connected to the vacuum tank 16, and the vacuum tank 16 is connected to the vacuum pump 17. When the vacuum pump 17 is activated, so that it can actively extract the gas in the vacuum tank 16, so as to make the vacuum tank 16 form a vacuum, and then generate a negative pressure on the mold cavity 5, so that the gas in the mold cavity 5 is actively sucked out, so as to avoid the generation of bubbles between the bottle embryo 20 and the label plate 21.

Furthermore, as shown in FIG. 2, the vacuum suction assembly 4 further comprises a check valve 18, the check valve 18 is arranged on the ventilation pipe 15, and the check valve 18 is used to prevent external gas from flowing back into the mold cavity 5.

Specifically, the check valve 18 is also arranged on the ventilation pipe 15, and the check valve 18 enables the gas in the ventilation pipe 15 to complete the flow from the mold cavity 5 to the vacuum tank 16 only, which prevents the gas in the vacuum tank 16 from flowing back into the mold cavity 5, so as to improve the yield of the decoration of the bottle embryo 20.

Furthermore, as shown in FIG. 2, the vacuum suction assembly 4 further comprises an inductive member 19, the inductive member 19 is disposed on a splicing surface of the second module 11 and the inductive member 19 is used for sensing whether or not the first module 10 is spliced with the second module 11.

Specifically, in one embodiment, a inductive member 19 is arranged on the splicing surface of the second module 11, which can sense whether the first module 10 is spliced with the second module 11, and the inductive member 19 is electrically connected with the external controller; in the implementation of the present disclosure, the inductive member 19 can also be set on the splicing surface of the first module 10, when the first module 10 is spliced with the second module 11 When the first module 10 is spliced with the second module 11, the inductive member 19 sends a signal to the external controller, and the external controller can control the start of the vacuum pump 17 to actively suction out the gas in the mold cavity 5, and when the first module 10 is not spliced with the second module 11, the inductive member 19 sends a signal to the external controller again, and the external controller controls the stopping of the vacuum pump 17, in order to realize the intelligent processing of suctioning out the gas in the mold cavity 5, and it can be matched with the time of blow molding so as to facilitate the suction process at the same time of blow molding, and when the blow molding is finished, the suction process can be stopped. In the embodiment of the present disclosure, the inductive member 19 is a magnetic position sensor.

In one embodiment of the present disclosure, the blow mold for plastic bottle further comprises a blowing assembly 7, which can be inserted into the blowing port 6 to facilitate the blowing process of the bottle embryo 20.

The following is a detailed description of the structure and function of a blow mold for plastic bottle in one embodiment of the present disclosure in combination with a specific use scenario:

When using the present disclosure, the bottle embryo 20 is first placed in the mold cavity 5, and two pieces of label plate 21 are placed against the mold cavity 5, and then the first module 10 and the second module 11 are spliced together and combined, and then the blowing assembly 7 is inserted into the blowing port 6 to blow mold the bottle embryo 20 in the mold body 1. During the blowing process, the gas between the bottle embryo 20 and the label plate 21 is discharged to the two exhaust channels 3 through the two ventilation grooves 2. At the same time, starting the vacuum pump 17, the gas in the vacuum tank 16 can be actively extracted, so that the vacuum tank 16 forms a vacuum, and then negative pressure is generated on the mold cavity 5, and the gas in the mold cavity 5 is actively suctioned out to accelerate the exhaust, to avoid the generation of air bubbles between the bottle embryo 20 and the label plate 21, and to enhance the adhesion between the molded bottle embryo 20 and the label plate 21, at the same time, to avoid the excess gas between the label plate 21 and the mold to the label plate 21. In addition, while speeding up the exhaustion, it also sucks out the air bubbles generated between the stacking of the structural layers 12, avoiding the phenomenon of the delamination between the structural layers 12 and improving the yield rate and improving the appearance quality of the product.

When the first module 10 is spliced closed with the second module 11, the inductive member 19 sends a signal to the external controller, and the external controller controls the startup of the vacuum pump 17 to actively suction out the gas in the mold cavity 5, and when the first module 10 is separated from the second module 11, the inductive member 19 sends a signal to the external controller again, and the external controller controls the stopping of the vacuum pump 17 once again to achieve the intelligent processing of gas suction out of the mold cavity 5, and can be matched with the time of blow molding so that the suction processing can be stopped when the blow molding is finished.

In summary, the present disclosure provides a blow mold for plastic bottle comprising: a mold body 1, the mold body 1 comprises a mold cavity 5 used to hold a bottle embryo 20 and a blowing port 6 connected to the mold cavity 5. The blow mold for plastic bottle further comprises: two exhaust channels 3, a label plate 21, a vacuum suction assembly 4; the two exhaust channels 3 are symmetrically arranged on front side and rear side of the mold body 1, the two exhaust channels 3 are connected to the mold cavity 5; the label plate 21 arranged in the mold cavity 5 is adsorbed on the first module 10 and the second module 11 before blow molding, and is expanded to form a bottle body after blow molding; and the label plate 21 is bonded to the outer surface of the bottle body; the vacuum suction assembly 4 is symmetrically located on front side and rear side of the mold body 1 and is connected to the two exhaust channels 3; and the vacuum suction assembly 4 is used to suction out the gas in the mold cavity 5. the present disclosure, by opening the two exhaust channels 3 on the mold body 1, increases the amount of exhaust and then make the gas discharge in the mold cavity 5 larger, and reduce the generation of bubbles between the bottle embryo 20 and the label plate 21. The two exhaust channels 3 are also connected to the vacuum suction assembly 4 outside, which in turn allows the vacuum suction assembly to be activated during blow molding of the bottle embryo 20, to enhance the adhesion between the molded bottle embryo 20 and the label plate 21, and at the same time to avoid that excess gas between the label plate 21 and the mold have an effect on the aesthetics of the label plate 21. Furthermore, while accelerating the exhaust, the air bubbles generated between the stacking of the structural layers 12 are also sucked out, it can avoid the phenomenon of delamination between the structural layers 12, increase the yield rate and improve the quality of the product appearance.

Other embodiments of the present disclosure will readily come to mind to those skilled in the art upon consideration of the specification and practice of the embodiments disclosed herein. The present disclosure is intended to cover any variations, uses, or adaptations of the present disclosure that follow the general principles of the present disclosure and include common knowledge or customary technical means in the art not disclosed herein. The specification and embodiments are to be regarded as exemplary only, and the true scope and spirit of the present disclosure are indicated by the claims.

What is claimed is:

1. A blow mold for plastic bottle, includes a mold body, the mold body is arranged with a mold cavity used to contain a bottle embryo and a blowing port connected to the mold cavity, wherein comprises:
two exhaust channels, the two exhaust channels are arranged on both sides of the mold body, the two exhaust channels are connected to the mold cavity;
a label plate, the label plate is arranged in the mold cavity;
a vacuum suction assembly, the vacuum suction assembly is arranged outside the mold body and is connected to the two exhaust channels, the vacuum suction assembly is used to suck out gas from the mold cavity; and
the label plate is adsorbed within the mold cavity before blow molding, and the label plate is bonded to an outer surface of the bottle embryo during blow molding with expansion of the bottle embryo.

2. The blow mold for plastic bottle according to claim 1, wherein the blow mold further comprises two ventilation grooves, the two ventilation grooves are connected to the two exhaust channels and the mold cavity, and the two ventilation grooves are arranged in the mold body, each of the two ventilation grooves comprises a main flow path and three auxiliary flow paths, the three auxiliary flow paths are uniformly arranged along a vertical direction from top to bottom and are connected to the mold cavity, the main flow path is connected to the two exhaust channels.

3. The blow mold for plastic bottle according to claim 2, wherein the mold body comprises a first module and a second module, the first module and the second module comprise a part of the mold cavity respectively, and the two ventilation grooves and the two exhaust channels are arranged in the second module.

4. The blow mold for plastic bottle according to claim 3, wherein the label plate comprises a plurality of structural layers, the plurality of the structural layers are arranged stacked.

5. The blow mold for plastic bottle according to claim 4, wherein the mold body further comprises positioning holes, the positioning holes are connected to the mold cavity used to adsorb and position the label plate.

6. The blow mold for plastic bottle according to claim 5, wherein the mold body further comprises a vacuum pipeline, the vacuum pipeline is connected to the positioning holes.

7. The blow mold for plastic bottle according to claim 6, wherein the vacuum suction assembly comprises:
a pneumatic connecting member, the pneumatic connecting member is arranged on front side and rear side of the mold body and connected to the two exhaust channels;
a ventilation pipe, the ventilation pipe is connected to the connecting member;
a vacuum tank, the vacuum tank is arranged at one end of the ventilation pipe away from the mold body; and
a vacuum pump, the vacuum pump is connected to the vacuum tank and used to extract gas from the vacuum tank.

8. The blow mold for plastic bottle according to claim 7, wherein the vacuum suction assembly further comprises a check valve, the check valve is arranged on the ventilation pipe, and the check valve is used to prevent the external gas from flowing back into the mold cavity.

9. The blow mold for plastic bottle according to claim 8, wherein the vacuum suction assembly further comprises an inductive member, the inductive member is arranged on a splicing surface of the second module, and the inductive member is used for sensing whether the first module is spliced with the second module.
